(19) United States
(12) Patent Application Publication
(10) Pub. No.: US 2013/0282998 A1
(43) Pub. Date: Oct. 24, 2013

(54) BACKUP SYSTEM AND BACKUP METHOD

(71) Applicants: Ryosuke Tatsumi, Yokohama (JP); Yoshiaki Eguchi, Yokohama (JP); Kohei Tatara, Yokohama (JP); Hisaharu Takeuchi, Odawara (JP)

(72) Inventors: Ryosuke Tatsumi, Yokohama (JP); Yoshiaki Eguchi, Yokohama (JP); Kohei Tatara, Yokohama (JP); Hisaharu Takeuchi, Odawara (JP)

(73) Assignee: HITACHI, LTD., Tokyo (JP)

(21) Appl. No.: 13/509,174

(22) PCT Filed: Apr. 24, 2012
(86) PCT No.: PCT/JP2012/002808

§ 371 Date: May 10, 2012

(51) Int. Cl. G06F 12/16

(52) U.S. Cl. 711/162; 711/E12.103

(57) ABSTRACT

A backup system and backup method with which the processing time can be shortened without increasing the overhead and burden on the system administrator in a two-stage backup.

In a backup system which executes a two-stage backup, the storage apparatus searches for a secondary volume which can be paired with a primary volume on the basis of the pair create instruction, determines whether the volume size of the secondary volume obtained as a search result is greater than the volume size of the primary volume and, if the volume size of the secondary volume is greater than the volume size of the primary volume, sets the volume size of the secondary volume as the same size as the volume size of the primary volume without changing the substantial volume size of the secondary volume, and notifies the host of information on the set volume size of the secondary volume and information indicating that a pair has been created.

### TECHNICAL FIELD

The present invention relates to a backup system and backup method, and is suitably applied to a backup system and backup method with which, overall, a two-stage backup is executed by executing a backup to a backup volume from a read/write target volume in particular and executing a backup from the backup volume to an auxiliary storage device.

### BACKGROUND ART

Conventionally, backup systems which are configured by interconnecting a host, a storage apparatus, and a tape device exist. In such backup systems, the host performs various tasks by executing application programs. Further, when performing the various tasks, the host transmits a read request or write request to the storage apparatus and, if necessary, transmits a backup request to the storage apparatus.

The storage apparatus is configured comprising a volume which serves as a read/write target storage area, and reads various data from the read/write target volume in accordance with a read request from the host and writes various data to the read/write target volume in accordance with a write request. Further, the storage apparatus executes backups in accordance with backup requests from the host.

Various ways for performing backups exist. For example, the storage apparatus is configured comprising a read/write target volume from/to which various data is read/written in accordance with a read request or write request from the host, and a backup volume which is paired with the read/write target volume. A backup is executed by storing a snapshot in the backup volume. Note that a snapshot is a data storage image at a certain time point.

Hereinbelow, the read/write target volume will be called the primary volume, and the backup volume, which is paired with the primary volume, will be called the secondary volume.

Furthermore, in this backup system, the tape device stores a snapshot which is stored in the secondary volume in accordance with a backup request from the host. In this case, as an overall backup system, a backup is first executed from the primary volume to the secondary volume, and then a backup is made from the secondary volume to the tape device, and therefore, overall, a two-stage backup is executed.

A backup in two stages will be referred to hereinbelow simply as a two-stage backup.

The advantages of executing a two-stage backup include the advantage that, if backup data (snapshot data, for example) is to be finally stored in an auxiliary storage device with a low processing speed such as a tape device, by storing the backup data via the secondary volume rather than storing the backup data directly in the tape device, I/Os to/from the primary volume need not be stopped.

Technology for pairing the primary volume with the secondary volume includes, for example, IBM z/OS DFSMS Advanced Copy Services disclosed by IBM Corp. z/OS is a mainframe OS (Operating System). Further, DFSMS is a mainframe DASD (Direct Access Storage Device) management tool. With IBM pairing technology, pairing (copying) can be performed if the volume size of the primary volume is equal to or less than the volume size of the secondary volume, for example.

Further, PTL1 discloses technology for enlarging or reducing the volume size in accordance with an instruction from the host.

### CITATION LIST

### Patent Literature

PTL 1: Japanese Patent Publication No. 4369520

### SUMMARY OF INVENTION

### Technical Problem

Here, if a two-stage backup is executed in volume units, when the volume size of the secondary volume is greater than the volume size of the primary volume, a backup to a tape device comes to be executed for unnecessary areas. Accordingly, there is then the problem that the processing time for the backup is unnecessarily long. For example, even though, if the volume size of the primary volume is 100 GB and the volume size of the secondary volume is 120 GB, the volume size which is actually to be backed up is 100 GB, a 120 GB backup is made to the tape device.

If pairing (copying) is performed using conventional technology, there is then the problem that the processing time for a backup as described above takes an unnecessarily long time. Further, if the pairing is made after changing the volume size of the secondary volume using the technology of claim 1 to the same size as the primary-volume volume size, unnecessary backups can be eliminated. However, there is a problem in that, with the technology according to PTL1 alone, it is time-consuming for the system administrator ordering the capacity change and there is an increased burden on the system administrator. Furthermore, there is also a problem in that an overhead is generated because processing to change the capacity is then required.

Therefore, the present invention was conceived in view of the above points, and provides a backup system and a backup method with which the processing time can be shortened without increasing the overhead and burden on the system administrator in a two-stage backup.

### Solution to Problem

In order to solve this problem, the present invention provides a backup system in which a host, a storage apparatus, and an auxiliary storage device are interconnected and which, in accordance with a backup request from the host, executes a two-stage backup by means of the storage apparatus and the auxiliary storage device, wherein, upon receiving a pair create instruction from the host, the storage apparatus specifies a primary volume and a secondary volume on the basis of the received pair create instruction, determines whether the volume size of the specified secondary volume is greater than the volume size of the primary volume and, if the volume size of the secondary volume is greater than the volume size of the primary volume, sets, after pair creation, the volume size of the secondary volume as the same size as the volume size of the primary volume without changing the actual volume size, and notifies the host of the set volume size of the secondary volume.

Furthermore, in order to solve this problem, the present invention provides a backup method for a backup system in which a host, a storage apparatus, and an auxiliary storage device are interconnected and which, in accordance with a backup request from the host, executes a two-stage backup by means of the storage apparatus and the auxiliary storage device, the backup method comprising a first step in which, upon receiving a pair create instruction from the host, the storage apparatus specifies a primary volume and a secondary volume on the basis of the received pair create instruction, and determines whether the volume size of the secondary volume obtained as a search result is greater than the volume size of the primary volume; and a second step in which, if the volume size of the secondary volume is greater than the volume size of the primary volume, the storage apparatus sets, after pair creation, the volume size of the secondary volume as the same size as the volume size of the primary volume without changing the actual volume size, and notifies the host of the set volume size of the secondary volume.

### Advantageous Effects of Invention

With the present invention, the processing time can be shortened without increasing the overhead and burden on the system administrator in a two-stage backup.

### BRIEF DESCRIPTION OF DRAWINGS

FIG. 1 is a block diagram showing an overall configuration of a backup system.

FIG. 2 is a block diagram showing a logical configuration of a backup system.

FIG. 3 is a block diagram showing a functional configuration of a host.

FIG. 4 is a block diagram showing a functional configuration of a storage apparatus.

FIG. 5 is a conceptual diagram of the structure of volume setting information.

FIG. 6 is a conceptual diagram showing the structure of volume management information.

FIG. 7 is a conceptual diagram showing the structure of pairing information.

FIG. 8 is a conceptual diagram showing virtual VOL page assignment information.

FIG. 9 is a conceptual diagram showing pair creation instruction parameters.

FIG. 10 is a conceptual diagram showing VOL state change notification parameters.

FIG. 11 is a conceptual diagram showing VOL information request parameters.

FIG. 12 is a conceptual diagram showing VOL state response parameters.

FIG. 13 is a conceptual diagram showing pair delete instruction parameters.

FIG. 14 is a flowchart showing pair creation processing.

FIG. 15 is a flowchart showing pair deletion processing.

FIG. 16 is a flowchart showing pair create setting processing.

FIG. 17 is a flowchart showing pair deletion setting processing.

FIG. 18 is a flowchart showing page release processing.

FIG. 19 is a flowchart showing asynchronous page release setting processing.

FIG. 20 is a flowchart showing asynchronous page release processing.

FIG. 21 is a flowchart showing volume dump processing.

FIG. 22 is a flowchart showing virtual VOL page assignment processing.

### DESCRIPTION OF EMBODIMENTS

An embodiment of the present invention will be described in detail with reference to the drawings.

### (1) Backup System Configuration

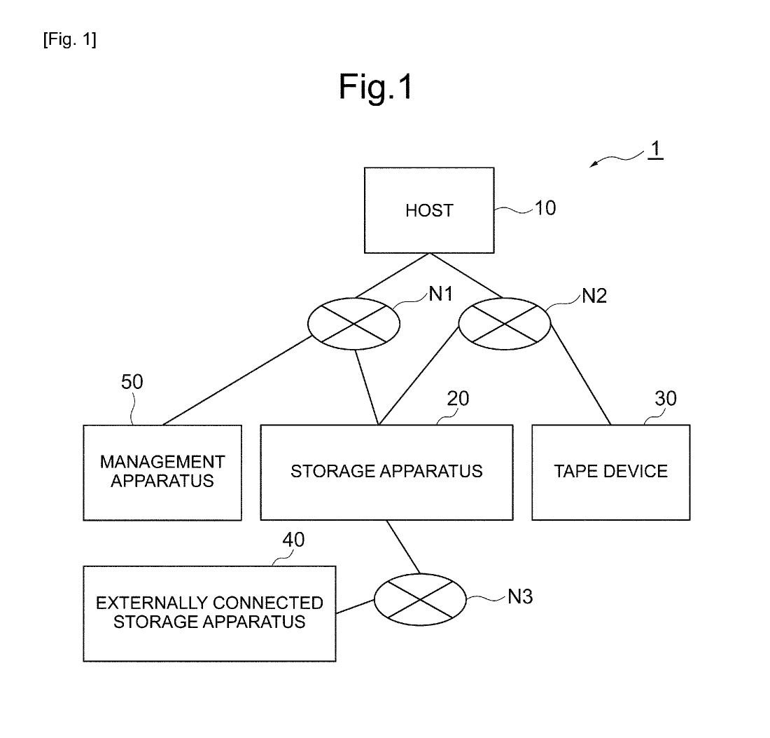

FIG. 1 shows the overall configuration of a backup system 1. This backup system 1 is configured comprising a host 10, a storage apparatus 20, a tape device 30, an externally connected storage apparatus 40, and a management apparatus 50. Further, the host 10, storage apparatus 20, tape device 30, externally connected storage apparatus 40, and management apparatus 50 are connected via networks N1 to N3 such as LAN (Local Area Network).

The host 10 is a higher-level computer which is configured comprising a CPU (Central Processing Unit), a RAM (Random Access Memory), and a ROM (Read Only Memory), and the like. The host 10 transmits read requests, write requests, and backup requests to the storage apparatus 20 or the tape device 30.

The storage apparatus 20 is a computer configured comprising a CPU, a RAM, and a ROM, and the like. The storage apparatus 20 is configured comprising a volume which is a read/write target storage area, which reads various data from the read/write target volume in accordance with a read request from the host 10, and writes various data to the read/write target volume in accordance with a write request. Further, upon receipt of a backup request from the host 10, the storage apparatus 20 executes a backup in accordance with the received backup request.

Various ways for performing backups exist. For example, the storage apparatus 20 is configured comprising a read/write target volume (primary volume) for reading/writing various data in accordance with a read request or write request from the host 10, and a backup volume (secondary volume) which is paired with the read/write target volume, and performs a backup by storing a snapshot and real data with substance in the secondary volume. Note that even though the secondary volume may be a logical virtual volume or a real volume with substance, in this embodiment, a case is mainly described where the secondary volume is a virtual volume.

The tape device 30 is a magnetic tape which is configured comprising a magnetic medium and is an auxiliary storage device which is used as additional support separate from the main storage device such as the storage apparatus 20.

The externally connected storage apparatus 40 is a computer which is configured comprising a CPU, a RAM, and a ROM and so on. If the secondary volume in the storage apparatus 20 is not a virtual volume but a real volume, for example, the externally connected storage apparatus 40 is a storage device which provides the real volume to the storage apparatus 20.

The management apparatus 50 is a computer which is configured comprising a CPU, a RAM, and a ROM, and the like. The management apparatus 50 is an apparatus enabling the system administrator to manage the backup system 1, and which, for example, orders the storage apparatus 20 instead of the host 10 to create a pairing from a primary volume and a secondary volume, and manages the correspondence relationship between the paired primary and secondary volumes.

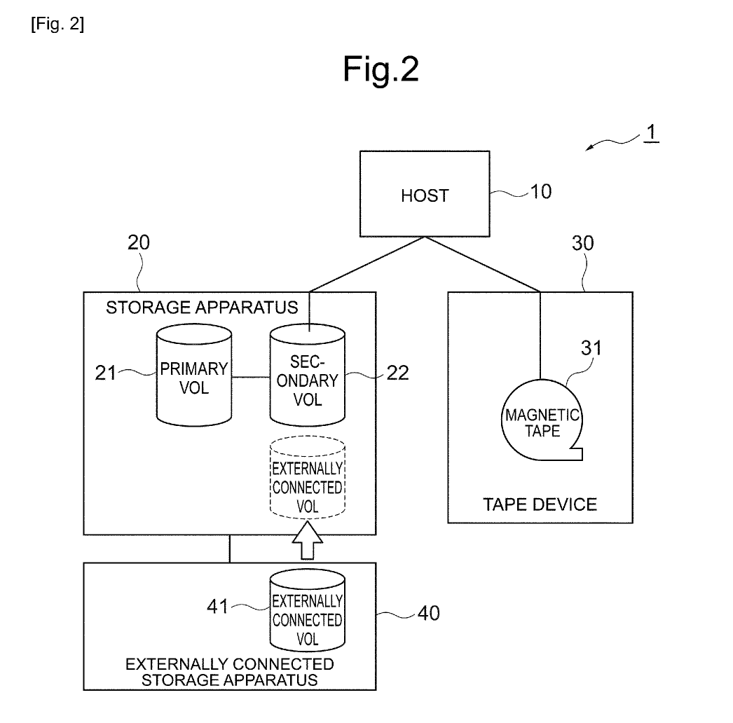

FIG. 2 shows the logical configuration of the backup system 1.

The host 10 is connected to the storage apparatus 20 and the tape device 30 and transmits a read request, write request, or backup request to the storage apparatus 20. Further, when transmitting a backup request, the host 10 transmits a pair create instruction or pair delete instruction to the storage apparatus 20.

The storage apparatus 20 comprises a primary VOL (primary volume) 21 and a secondary VOL (secondary volume) 22, and receives various requests and various instructions from the host 10. For example, if a pair create instruction is received from the host 10, the storage apparatus 20 creates a pairing between the primary volume 21 and the secondary volume 22. Further, if the secondary volume 22 in the pair create instruction from the host 10 is not a virtual volume but a real volume, the storage apparatus 20 makes an externally connected VOL (externally connected volume) 41 which is provided by the external storage apparatus 40 the secondary volume and creates a pairing between the externally connected volume 41 and the primary volume 21.

The tape device 30 comprises a magnetic tape 31 and stores snapshots and real data copied to the secondary volume 22. Accordingly, a two-stage backup of the backup system 1 overall comes to be executed.

The externally connected storage apparatus 40 comprises the externally connected volume 41 and provides the externally connected volume 41 to the storage apparatus 20.

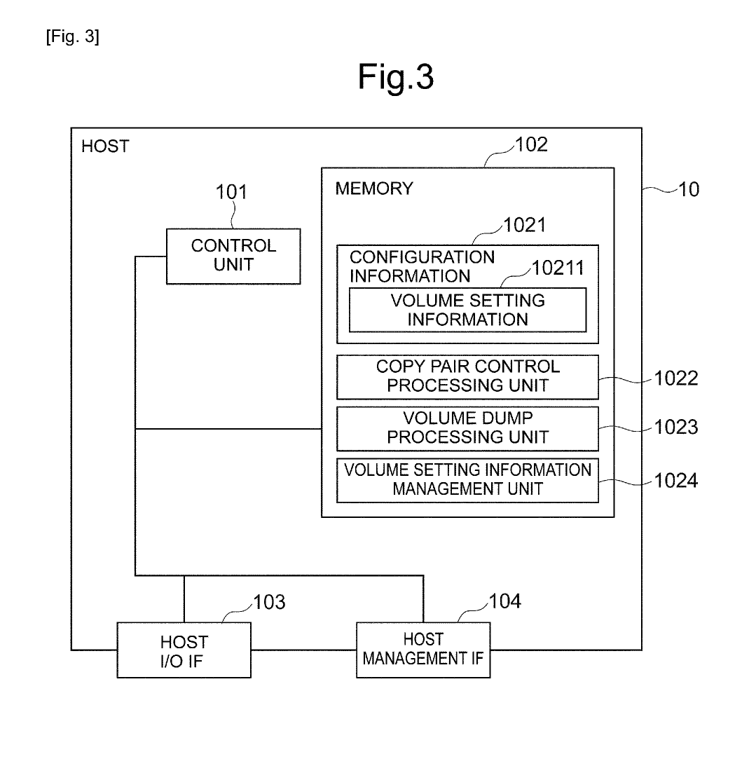

FIG. 3 shows a functional configuration of the host 10. The host 10 is configured comprising a control unit 101, a memory 102, a host I/O IF 103, and a host management IF 104.

The control unit 101 is configured comprising a CPU, a RAM, and a ROM and so on, and centrally controls the operation of the host 10 by co-operating with the various programs stored in the memory 102.

The memory 102 is configured comprising configuration information 1021, a copy pair control processing unit 1022, a volume dump processing unit 1023, and a volume setting information management unit 1024.

The configuration information 1021 includes volume setting information 10211, and the volume setting information 10211 contains information enabling volumes to be managed by the host 10. The specific information contained in the volume setting information 1021 is volume number and size information.

The copy pair control processing unit 1022 is a program for transmitting a pair create instruction and a pair delete instruction to the storage apparatus 20.

The volume dump processing unit 1023 is a program for reading the secondary volume 22 and writing the read data to the magnetic tape 31.

The volume setting information management unit 1024 is a program for acquiring information on the volume size of the primary volume 21 and secondary volume 22 from the storage apparatus 20 and enables the acquired volume size information to be managed by the host 10. The volume setting information management unit 1024 manages volume sizes by storing the acquired volume size information in the volume setting information 10211.

The host I/O IF 103 is an interface for sending and receiving various data and various commands and so on between the storage apparatus 20, the tape device 30, the externally connected storage apparatus 40, and the management apparatus 50.

The host management I/F 104 comprises a mouse and/or keyboard or the like and is an interface enabling instructions from the system administrator to be received.

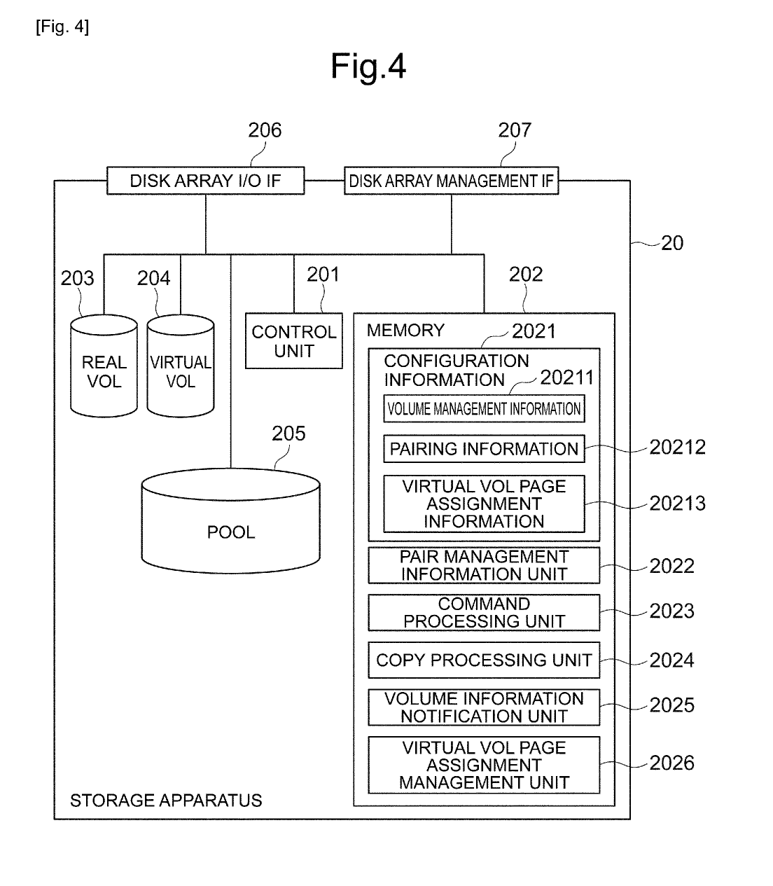

FIG. 4 shows a functional configuration of the storage apparatus 20. The storage apparatus 20 is configured comprising a control unit 201, a memory 202, a real VOL (real volume) 203, a virtual VOL (virtual volume) 204, a pool 205, a disk array I/O IF 206, and a disk array management IF 207.

The control unit 201 is configured comprising a CPU, a RAM, and a ROM, or the like, and centrally controls the operation of the storage apparatus 20 by co-operating with the various programs stored in the memory 202.

The memory 202 is configured comprising configuration information 2021, a pair management information unit 2022, a command processing unit 2023, a copy processing unit 2024, a volume information notification unit 2025, and a virtual VOL (virtual volume) page assignment management unit 2026.

The configuration information 2021 includes volume management information 20211, pairing information 20212, and virtual VOL (virtual volume) page assignment information 20213.

The volume management information 20211 includes information enabling management of volumes by the storage apparatus 20. The specific information contained in the volume management information 20211 is volume type information indicating real volumes or virtual volumes, volume size information, and pair state information indicating if a pairing has been created, and so on.

The pairing information 20212 includes information for managing pairings between the primary volume 21 (here the real volume 203) and the secondary volume 22 (here the virtual volume 204). The specific information contained in the pairing information 20212 is number information for identifying the paired real volume 203 and virtual volume 204, and so on.

The virtual volume page assignment information 20213 includes information enabling management of page assignment states in the virtual volume 204. The specific information contained in the virtual volume page assignment information 20213 is information on the next assignable page number when a page is to be assigned to the virtual volume 204, information on page numbers to be discarded, and information on the final page number in the virtual volume.

The pair management information unit 2022 is a program enabling management of the relationships between the real volume 203 and the virtual volume 204 paired in the storage apparatus 20.

The command processing unit 2023 is a program for analyzing and processing commands of various requests such as read requests, write requests, and backup requests from the host 10, and various instructions such as a pair create instruction and a pair delete instruction.

The copy processing unit 2024 is a program for performing a two-stage backup by executing a backup from the real volume 203 to the virtual volume 204 in accordance with a backup request from the host 10, and performing a backup from the virtual volume 204 to the magnetic tape 31.

The volume information notification unit 2025 is a program for notifying the host 10 of information on the volume sizes of the real volume 203 and the virtual volume 204, and so on. Note that, even though the volume size of the real volume 203 is 100 GB and the actual volume size of the virtual volume 204 which is paired with the real volume 203 is 120 GB, for example, by applying the present invention, the volume information notification unit 2025 may report the actual volume size of the virtual volume as a smaller volume size than the real-volume volume size which is 100 GB.

The virtual volume page assignment management unit 2026 is a program for managing page assignment states for assignment to the virtual volume 204. The virtual volume page assignment management unit 2026 manages the page assignment states for assignment to the virtual volume 204 by updating information on the assignment states of pages which are stored in the virtual volume page assignment information 20213 in cases where a page is assigned to the virtual volume 204.

The real VOL (volume) 203 is a volume which is an actual read/write target in accordance with a read request or a write request from the host 10 and is a volume which functions as the primary volume 21.

The virtual VOL (volume) 204 is a backup volume for the real volume 203 and is a volume which functions as the secondary volume 22.

The pool 205 is a pool for storing snapshot differential data.

The disk array I/O IF 206 is an interface for transmitting and receiving various data and various commands and so on between the host 10, the tape device 30, the externally connected storage apparatus 40, and the management apparatus 50.

The disk array management I/F 207 comprises a mouse and/or keyboard, or the like, and is an interface enabling instructions from the system administrator to be received.

### (2) Configuration of Various Data

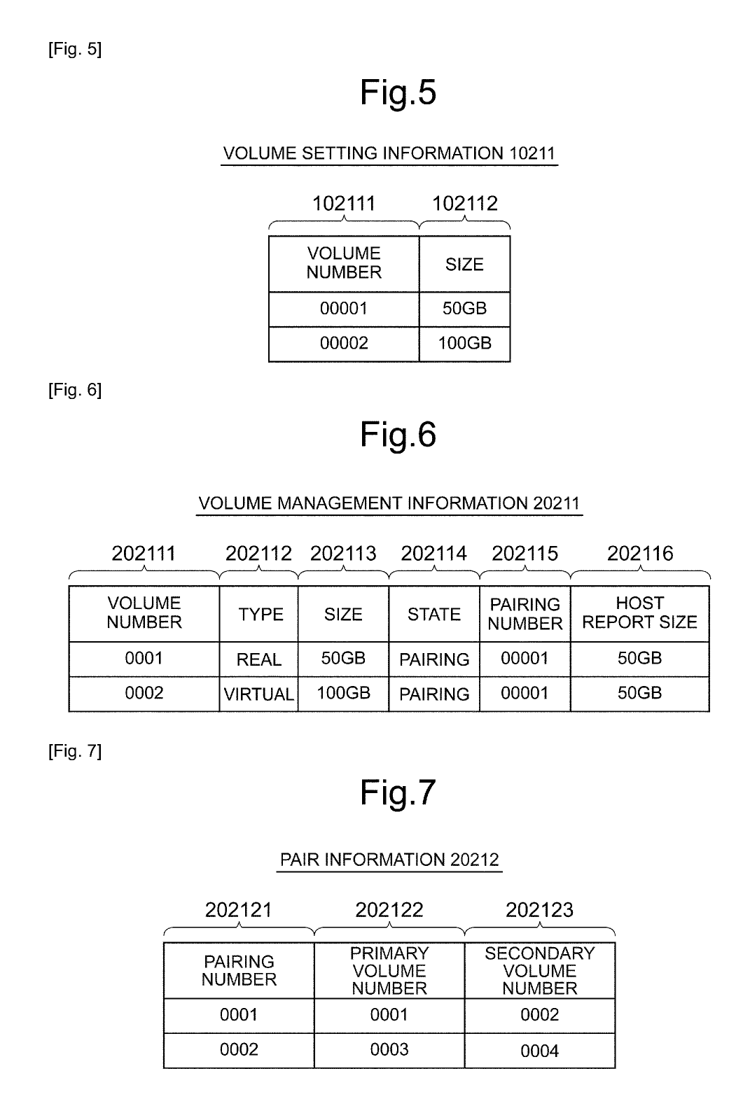

FIG. 5 shows a conceptual diagram of the volume setting information 10211 for managing volumes in the storage apparatus 20 of the host 10.

The volume setting information 10211 is configured from a volume number field 102111 and a size field 102112.

The volume number field 102111 stores volume numbers as identifiers for identifying a plurality of volumes which are formed in the storage apparatus 20. Further, the size field 102112 stores the volume sizes of the volumes formed in the storage apparatus 20.

Accordingly, in the case of FIG. 5, it can be seen that the volume size of the volume with the volume number 0001 is 50 GB.

FIG. 6 shows the conceptual diagram of the volume management information 20211 for managing volumes which are formed in the storage apparatus 20.

The volume management information 20211 is configured from a volume number field 202111, a type field 202112, a size field 202113, a state field 202114, a pair number field 202115, and a host report size field 202116.

The volume number field 202111 stores volume numbers as identifiers for identifying a plurality of volumes formed in the storage apparatus 20. Furthermore, the type field 202112 stores information indicating that the types of the volumes formed in the storage apparatus 20 are real volumes or virtual volumes.

Further, the size field 202113 stores the volume sizes of the volumes formed in the storage apparatus 20. In addition, the state field 202114 stores information indicating whether a pairing has been created. Note that, if a pairing is created between the primary volume 21 and the secondary volume 22, the states of the primary volume 21 and secondary volume 22 in the state field 202114 will both reflect the pairing.

Furthermore, the pair number field 202115 stores pair numbers for identifying the pairing. Note that, if a pairing has been created between the primary volume 21 and the secondary volume 22, the pair numbers of the primary volume 21 and secondary volume 22 in the pair number field 202115 will be the same numbers.

Further, the host report size field 202116 stores the volume sizes reported to the host 10. Note that this does not necessarily mean that the host report size field 202116 will store the actual volume size, rather, this field stores the volume size reported to the host 10.

Therefore, in the case of FIG. 6, for example, it can be seen that the type of the volume with the volume number 0002 is a virtual volume and the actual volume size is 100 GB. It can also be seen that the volume with the volume number 0002 is paired and that the pair number is 0001. In addition, it is clear that the volume size of the volume with the volume number 0002 is actually 100 GB but is reported to the host 10 as 50 GB.

FIG. 7 shows a conceptual diagram of pairing information 20212 for managing the pairings in the storage apparatus 20.

The pairing information 20212 is configured from a pair number field 202121, a primary volume number field 202122, and a secondary volume number field 202123.

The pair number field 202121 stores pair numbers for identifying pairings. The primary volume number field 202122 stores primary volume numbers for identifying the primary volumes 21. Further, the secondary volume number field 202123 stores secondary volume numbers for identifying the secondary volumes 22.

Therefore, in the case of FIG. 7, it can be seen that the volume numbers of the primary volume 21 and secondary volume 22 with the pair number 0001 are 0001 and 0002 respectively.

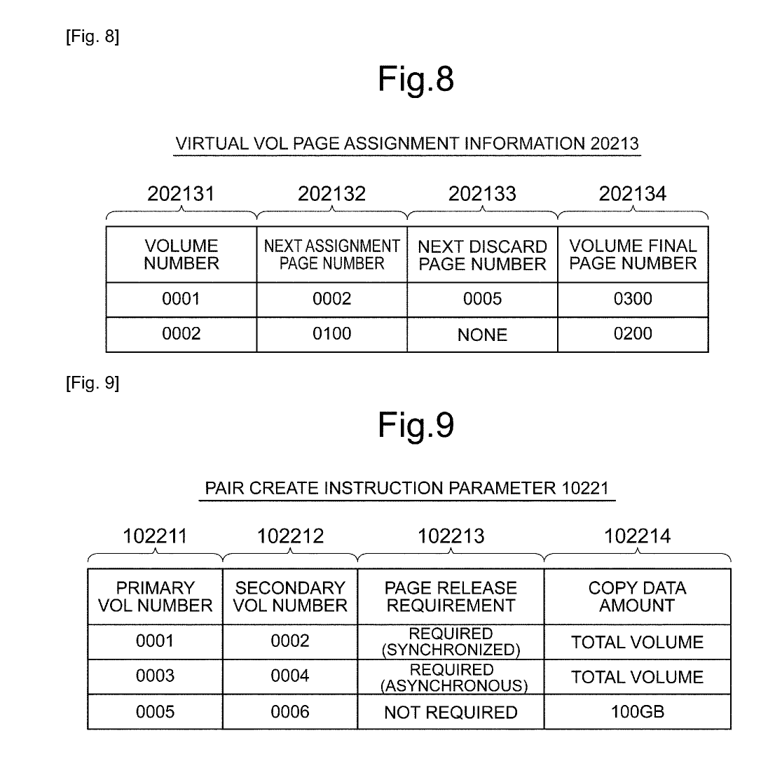

FIG. 8 is a conceptual diagram of virtual volume page assignment information 20213 for managing assignment states of pages in the virtual volume 204.

The virtual volume page assignment information 20213 is configured from a volume number field 202131, a next assigned page number field 202132, a next discard page number field 202133, and a volume final page number field 202134.

The volume number field 202131 stores volume numbers as identifiers for identifying a plurality of volumes formed in the storage apparatus 20. In addition, the next assigned page number field 202132 stores the page numbers of the next assignable pages when a page is to be assigned. Further, the next discard page number field 202133 stores page numbers of pages which are pages on which old data is stored and which are to be discarded. The volume final page number field 202134 stores page numbers of final pages.

Therefore, in the case of FIG. 8, it can be seen that, if a page is assigned to the virtual volume with the volume number 0001, a page with the page number 0002 is assigned. In addition, it is clear that the page to be discarded from the pages is the page with the page number 0005 in the virtual volume with the virtual volume 0001. It is also clear that the page number of the final page of the virtual volume with the volume number 0001 is 0300.

FIG. 9 shows a conceptual diagram of a pair create instruction parameter 10221 which is transmitted from the host 10 to the storage apparatus 20 when a pair create instruction is issued by the host 10 to the storage apparatus 20.

The pair create instruction parameter 10221 is configured from a primary volume number field 102211, a secondary volume number field 102212, a page release requirement field 102213, and a copy data amount field 102214.

The primary volume number field 102211 stores a primary volume number as the identifier of the primary volume 21 which is paired in the storage apparatus 20. Further, the secondary volume number field 102212 stores a secondary volume number as the identifier of the secondary volume 22 which is paired in the storage apparatus 20.

Further, the page release requirement field 102213 stores information such as whether a page of the secondary volume 22 is to be released during pair creation and, if a page is to be released, whether the page is released in synchronization with pair creation or released asynchronously to pair creation. Furthermore, the copy data amount field 102214 stores a copy data amount when copying is performed from the primary volume 21 to the secondary volume 22.

Therefore, in the case of FIG. 9, it can be seen, for example, that an instruction is issued to create a pairing between the primary volume 21 with the primary volume number 0001 and the secondary volume 22 with the secondary volume number 0002. Further, in this case, it is can be seen that when a pairing is created between the primary volume 21 and the secondary volume 22, an instruction is issued to release a page in the secondary volume 22 in synchronization with the pair creation processing. Furthermore, in this case, it can be seen that the instruction issued is to copy all the data stored in the primary volume 21 to the secondary volume 22.

It can also be seen, for example, that an instruction is issued to create a pairing between the primary volume 21 with the primary volume number 0003 and the secondary volume 22 with the secondary volume number 0004. Further, in this case, it is clear that, when a pairing is created between the primary volume 21 and the secondary volume 22, an instruction is issued to release a page of the secondary volume 22 asynchronously to the pair creation processing. Also in this case, it is clear that an instruction to copy all the data which is stored in the primary volume 21 to the secondary volume 22 has been issued.

In addition, it can be seen, for example, that an instruction is issued to create a pairing between the primary volume 21 with the primary volume number 0005 and the secondary volume 22 with the secondary volume number 0002. It can also be seen that there is no need to release a page of the secondary volume 22 when data is copied from the primary volume 21 to the secondary volume 22. It is also clear that an instruction is issued to copy 100 GB of the data stored in the primary volume 21 to the secondary volume 22.

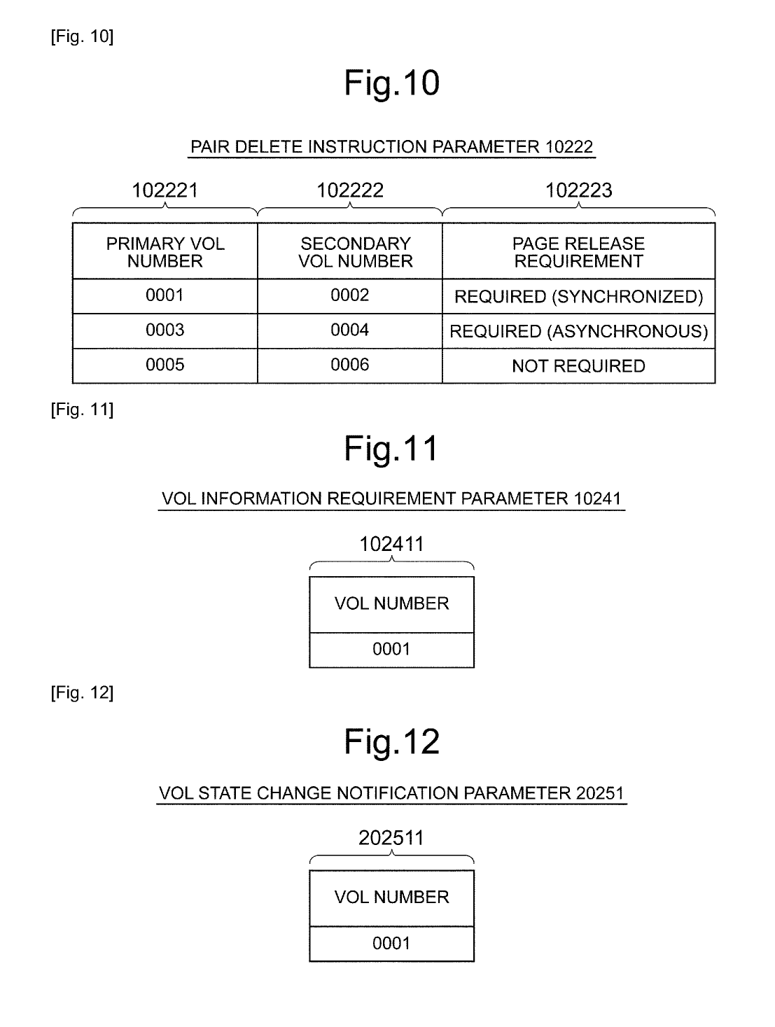

FIG. 10 shows a conceptual diagram of a pair delete instruction parameter 10222 which is transmitted from the host 10 to the storage apparatus 20 when an instruction to delete a pairing is issued by the host 10 to the storage apparatus 20.

The pair delete instruction parameter 10222 is configured from the primary volume number field 102221, a secondary volume number field 102222, and a page release requirement field 102223.

The primary volume number field 102221 stores a primary volume number as an identifier for the paired primary volume 21 in the storage apparatus 20. Further, the secondary volume number field 102222 stores a secondary volume number as the identifier for the paired secondary volume 22 in the storage apparatus 20.

Further, the page release requirement field 102223 stores information indicating whether to release a page in the secondary volume 22 when a pairing is deleted and, if a page is to be released, whether the page is released in synchronization with pair deletion or released asynchronously to pair deletion.

Therefore, in the case of FIG. 10, it can be seen that an instruction is issued to delete the pairing between the primary volume 21 with the primary volume number 0001 and the secondary volume 22 with the secondary volume 0002. Further, in this case, it can also be seen that an instruction is issued to release a page of the secondary volume 22 in synchronization with the pair deletion processing when the pairing between the primary volume 21 and the secondary volume 22 is deleted.

In addition, it can be seen that an instruction is issued to delete the pairing between the primary volume 21 with the primary volume number 0003 and the secondary volume 22 with the secondary volume number 0004. Further, in this case, it can be seen that an instruction is issued to release a page of the secondary volume 22 asynchronously to the pair deletion processing when the pairing between the primary volume 21 and the secondary volume 22 is deleted.

Furthermore, it is can be seen, for example, that an instruction is issued to delete the pairing between the primary volume 21 with the primary volume number 0005 and the secondary volume 22 with the secondary volume number 0002. Further, it can be seen that there is no need to release a page of the secondary volume 22 when the pairing between the primary volume 21 and the secondary volume 22 is deleted.

FIG. 11 shows a conceptual diagram of a VOL (volume) information requirement parameter 10241 which is transmitted from the host 10 to the storage apparatus 20 when the host 10 issues a request for volume information to the storage apparatus 20.

The volume information requirement parameter 10241 is configured from a volume number field 102411. The volume number field 102411 stores volume the number of the volume which was requested as the volume information to be acquired by the host 10.

Therefore, in the case of FIG. 11, it can be seen that the host 10 instructs the storage apparatus 20 to transmit information on the volume with the volume number 0001 to the host 10.

FIG. 12 shows a conceptual diagram of a VOL (volume) state change notification parameter 20251 which is transmitted from the storage apparatus 20 to the host 10 when the storage apparatus 20 issues notification to the host 10 that the state of a volume has changed.

The volume state change notification parameter 20251 is configured from a volume number field 202511. The volume number field 202511 stores the volume number of a volume whose volume state has changed as a result of pair creation or pair deletion and so on among the plurality of volumes formed in the storage apparatus 20.

Therefore, in the case of FIG. 12, it can be seen that notification is sent to the host 10 that the state of the volume with the volume number 0001 has changed.

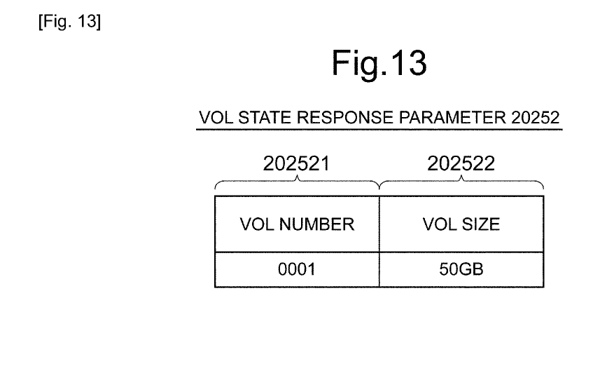

FIG. 13 shows a conceptual diagram of a VOL (volume) state response parameter 20252 which is transmitted from the storage apparatus 20 to the host 10 when the storage apparatus 20 issues a volume size notification to the host 10.

The volume state response parameter 20252 is configured from a volume number field 202521 and a volume size field 202522. The volume number field 202521 stores volume numbers as identifiers for identifying a plurality of volumes which are formed in the storage apparatus 20. Further, the volume size field 202522 stores the report volume size reported to the host 10.

Therefore, in the case of FIG. 13, it can be seen that notification is sent to the host 10 that the volume size of the volume with the volume number 0001 is 50 GB.

### (3) Processing Routine for Various Processing

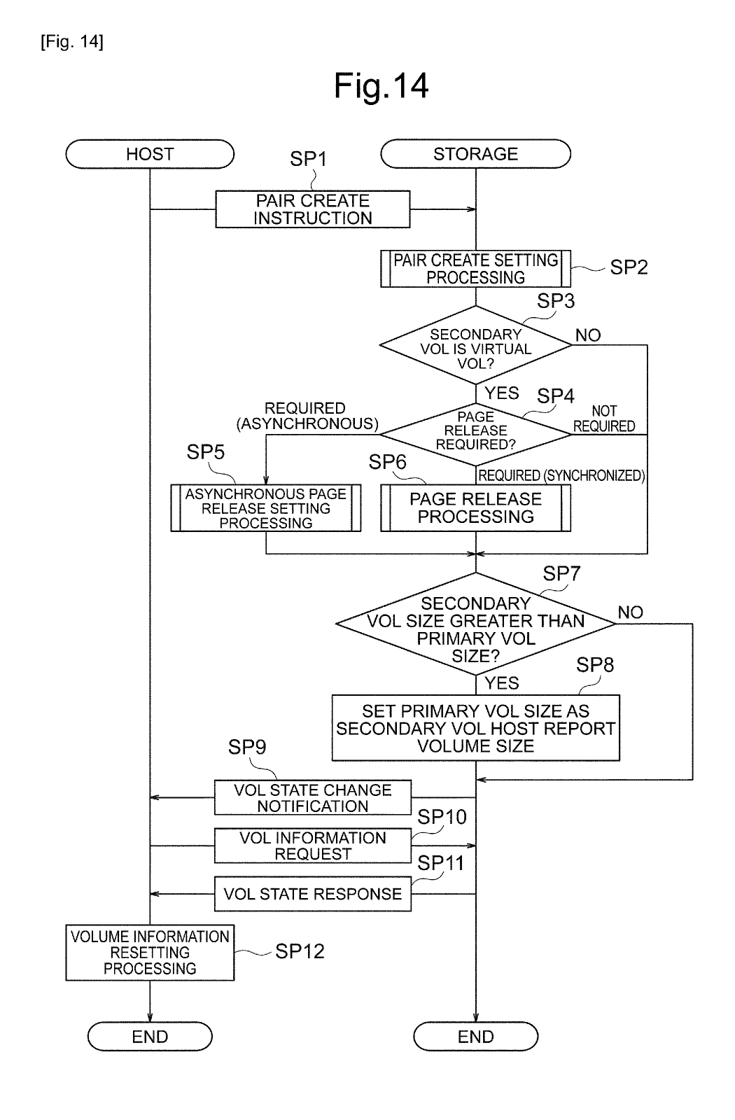

FIG. 14 shows a processing routine for pair creation processing. The pair creation processing is executed by the control unit 101 of the host 10 and the control unit 201 of the storage apparatus 20. Further, the pair creation processing is executed when the host 10 receives a pair create instruction from the system administrator. Hereinafter, for the sake of convenience in the description, the description is provided by taking the host 10 and the storage apparatus 20 as the subjects of the processing.

First, upon receiving the pair create instruction from the system administrator via the host management IF 104, the host 10 transmits a pair create instruction which contains the pair create instruction parameter 10221 (see FIG. 9) to the storage apparatus 20 (SP1).

Upon receiving the pair create instruction which is transmitted from the host 10, the storage apparatus 20 then executes pair creation setting processing (SP2).

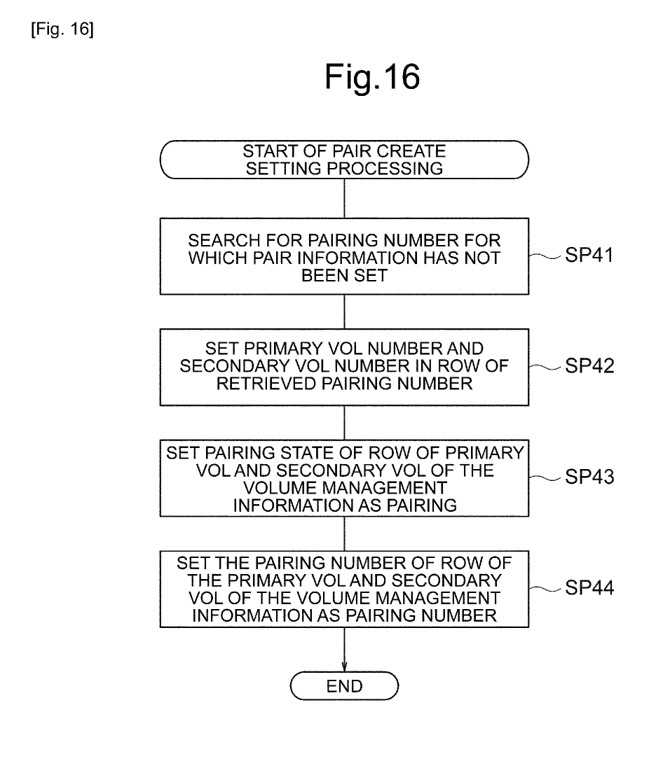

Although the pair creation setting processing will be described subsequently in FIG. 16, in summary, this is processing in which the storage apparatus 20 sets the volume numbers, states, and pair numbers of the primary volume 21 and secondary volume 22 as the volume management information 20211 on the basis of the pair create instruction parameter 10221. A pairing is thus created in the storage apparatus 20 by the pair creation setting processing.

The storage apparatus 20 then determines whether the secondary volume 22 in the created pairing between the primary volume 21 and secondary volume 22 is a virtual volume on the basis of the volume management information 20211 (SP3).

Upon obtaining a negative result in this determination, the storage apparatus 20 moves to step SP7. However, when an affirmative result is obtained in the determination of step SP3, the storage apparatus 20 determines whether page release is required on the basis of the pair create instruction parameter 10221 (SP4).

Upon obtaining the result in this determination that it is unnecessary to release a page, the storage apparatus 20 moves to step SP7. On the other hand, when a result is obtained in the determination of step SP4 that a page must be released, the storage apparatus 20 determines, on the basis of the pair create instruction parameter 10221, whether it is necessary to execute a page release in synchronization with the pair creation processing and whether it is necessary to execute a page release asynchronously to the page creation processing (SP4).

When a result is obtained that page release must be executed asynchronously, the storage apparatus 20 executes asynchronous page release setting processing (SP5).

If, on the other hand, a result is obtained that page release must be executed in synchronization, the storage apparatus 20 executes page release processing (SP6).

The storage apparatus 20 determines whether the volume size of the secondary volume 22 in the created pairing between the primary volume 21 and the secondary volume 22 is greater than the volume size of the primary volume 21 on the basis of the volume management information 20211 (SP7).

Upon obtaining a negative result in this determination, the storage apparatus 20 moves to step SP9. If, on the other hand, an affirmative result is obtained in the determination of step SP7, the storage apparatus 20 sets the volume size of the secondary volume 22 reported to the host 10 at the same volume size as the volume size of the primary volume 21 (SP8).

The storage apparatus 20 then transmits a volume state change notification which contains the volume state change notification parameter 20251 to the host 10 (SP9).

Upon receiving the volume state change notification transmitted from the storage apparatus 20, the host 10 transmits a volume information request to the storage apparatus 20 (SP10).

Upon receiving the volume information request transmitted from the host 10, the storage apparatus 20 transmits a volume state response which contains the volume state response parameter 20252 to the host 10 (SP11) and ends the processing of the storage apparatus 20 in the pair creation processing.

Upon receiving the volume state response which is transmitted from the storage apparatus 20, the host 10 executes volume information resetting processing for resetting the settings stored in the volume setting information 10211 (SP12), and ends the processing by the host 10 in the pair creation processing.

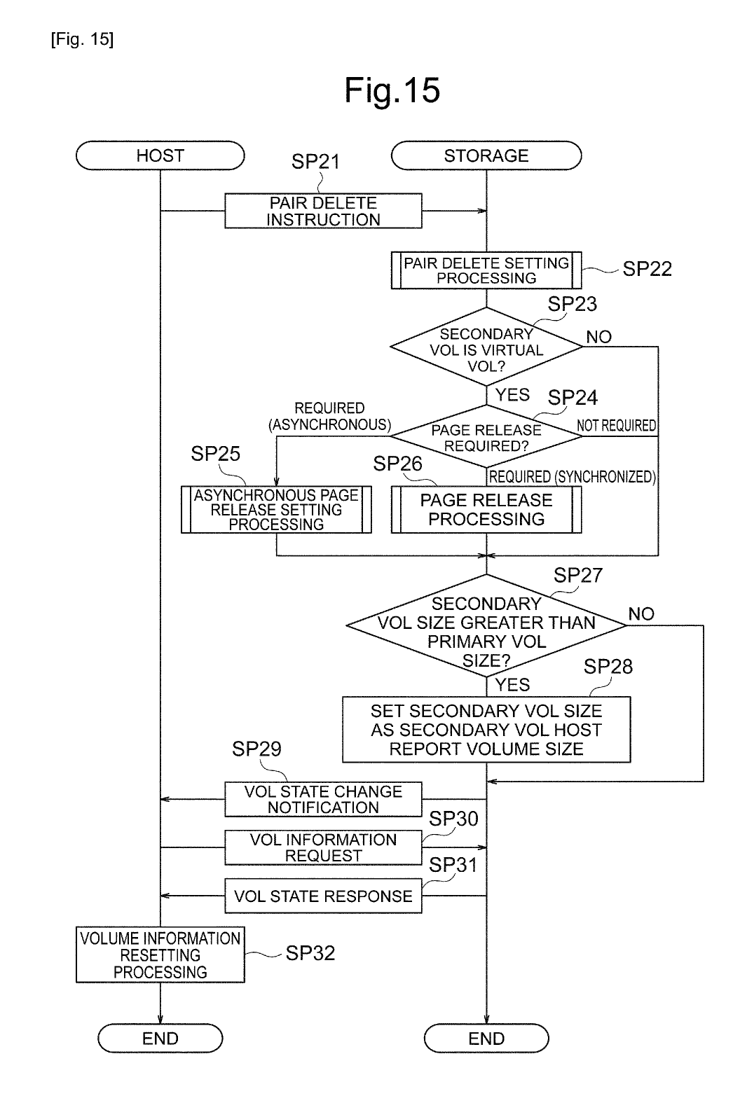

FIG. 15 shows a processing routine for pair deletion processing. The pair deletion processing is executed by the control unit 101 of the host 10 and the control unit 201 of the storage apparatus 20. Further, this pair deletion processing is executed when the host 10 receives a pair delete instruction from the system administrator. Hereinafter, for the sake of convenience in the description, the description is provided by taking the host 10 and the storage apparatus 20 as the subjects of the processing.

First, upon receiving the pair delete instruction from the system administrator via the host management IF 104, the host 10 transmits a pair delete instruction which contains the pair delete instruction parameter 10222 (see FIG. 10) to the storage apparatus 20 (SP21).

Upon receiving the pair delete instruction which is transmitted from the host 10, the storage apparatus 20 then executes pair deletion setting processing (SP22).

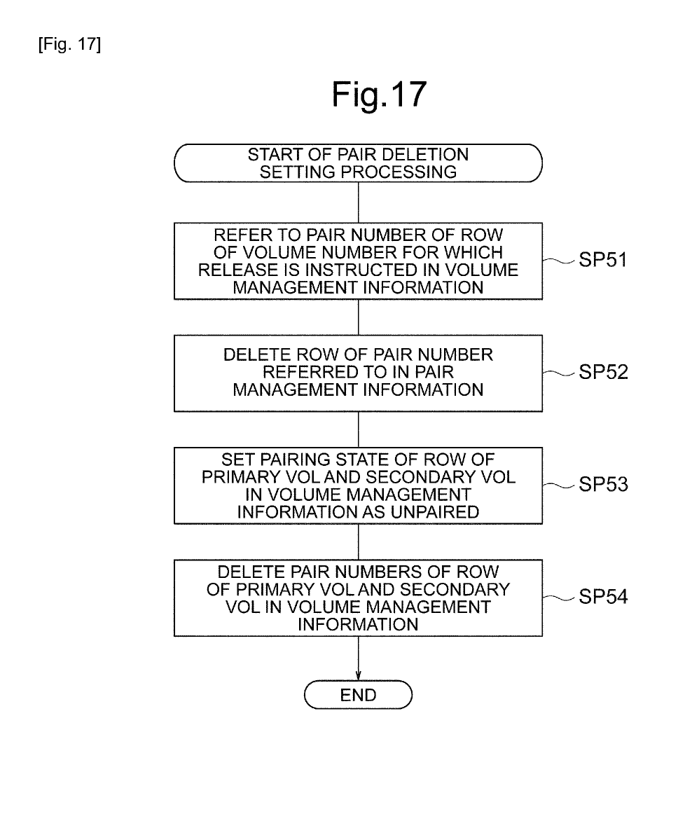

Although the pair deletion setting processing will be described subsequently in FIG. 17, in summary, this is processing in which the storage apparatus 20 sets the volume numbers, states, and pair numbers of the primary volume 21 and secondary volume 22 as the volume management information 20211 on the basis of the pair delete instruction parameter 10222. A pairing is thus deleted in the storage apparatus 20 by the pair deletion setting processing.

The storage apparatus 20 then determines whether the secondary volume 22 in the deleted pairing between the primary volume 21 and secondary volume 22 is a virtual volume on the basis of the volume management information 20211 (SP23).

Upon obtaining a negative result in this determination, the storage apparatus 20 moves to step SP27. However, when an affirmative result is obtained in the determination of step SP23, the storage apparatus 20 determines whether page release is required on the basis of the pair delete instruction parameter 10222 (SP24).

Upon obtaining the result in this determination that it is unnecessary to release a page, the storage apparatus 20 moves to step SP27. On the other hand, when a result is obtained in the determination of step SP24 that a page must be released, the storage apparatus 20 determines, on the basis of the pair delete instruction parameter 10222, whether it is necessary to execute a page release in synchronization with the pair deletion processing and whether it is necessary to execute a page release asynchronously to the page deletion processing (SP24).

When a result is obtained that page release must be executed asynchronously, the storage apparatus 20 executes asynchronous page release setting processing (SP25).

If, on the other hand, a result is obtained that page release must be executed in synchronization, the storage apparatus 20 executes page release processing (SP26).

The storage apparatus 20 determines whether the volume size of the secondary volume 22 in the deleted pairing between the primary volume 21 and the secondary volume 22 is greater than the volume size of the primary volume 21 on the basis of the volume management information 20211 (SP27).

Upon obtaining a negative result in this determination, the storage apparatus 20 moves to step SP29. If, on the other hand, an affirmative result is obtained in the determination of step SP27, the storage apparatus 20 sets the volume size of the secondary volume 22 reported to the host 10 at the same volume size as the volume size of the actual secondary volume 22 (SP28).

The storage apparatus 20 then transmits a volume state change notification which contains the volume state change notification parameter 20251 to the host 10 (SP29).

Upon receiving the volume state change notification transmitted from the storage apparatus 20, the host 10 transmits a volume information request to the storage apparatus 20 (SP30).

Upon receiving the volume information request transmitted from the host 10, the storage apparatus 20 transmits a volume state response which contains the volume state response parameter 20252 to the host 10 (SP31) and ends the processing of the storage apparatus 20 in the pair deletion processing.

Upon receiving the volume state response which is transmitted from the storage apparatus 20, the host 10 executes volume information resetting processing for resetting the settings stored in the volume setting information 10211 (SP32), and ends the processing by the host 10 in the pair deletion processing.

FIG. 16 shows a processing routine for pair creation setting processing. The pair creation setting processing is executed by way of co-operation between the control unit 201 of the storage apparatus 20 and the various programs stored in the memory 202. Further, the pair creation setting processing is executed when the storage apparatus 20 receives a pair create instruction from the host 10. Hereinafter, for the sake of convenience in the description, the control unit 201 will be described as the processing subject.

First, the control unit 201 searches for pair numbers for which pair information has not been set on the basis of the volume management information 20211 (SP41).

The control unit 201 then sets the volume numbers of the primary volume 21 and the secondary volume 22 in the primary volume number field 202122 and the secondary volume number field 202123 in the row of the pair number obtained as the search result on the basis of the pairing information 20212 (SP42).

The control unit 201 then sets the state fields 202114 of the row of the primary volume 21 and secondary volume 22 on the basis of the volume management information 20211 as paired (SP43).

The control unit 201 then sets pair numbers in the pair number field 202115 of the row of the primary volume 21 and the secondary volume 22 (SP44) on the basis of the volume management information 20211 and ends the pair creation setting processing.

FIG. 17 shows a processing routine for pair deletion setting processing. The pair deletion setting processing is executed by way of co-operation between the control unit 201 of the storage apparatus 20 and the various programs which are stored in the memory 202. Further, the pair deletion setting processing is executed when the storage apparatus 20 receives a pair delete instruction from the host 10. Hereinafter, for the sake of convenience, the control unit 201 will be described as the processing subject.

First, the control unit 201 refers to the pair number of the row of the volume number for which pairing deletion has been instructed on the basis of the volume management information 20211 (SP51).

The control unit 201 then deletes the row of the pair number obtained as the reference result on the basis of the pair information 20212 (SP52).

The control unit 201 then sets the state fields 202114 of the row of the primary volume 21 and secondary volume 22 on the basis of the volume management information 20211 as unpaired (SP53).

The control unit 201 then deletes the pair number of the pair number field 202115 of the row in the primary volume 21 and the secondary volume 22 on the basis of the volume management information 20211 (SP54) and ends the pairing deletion setting processing.

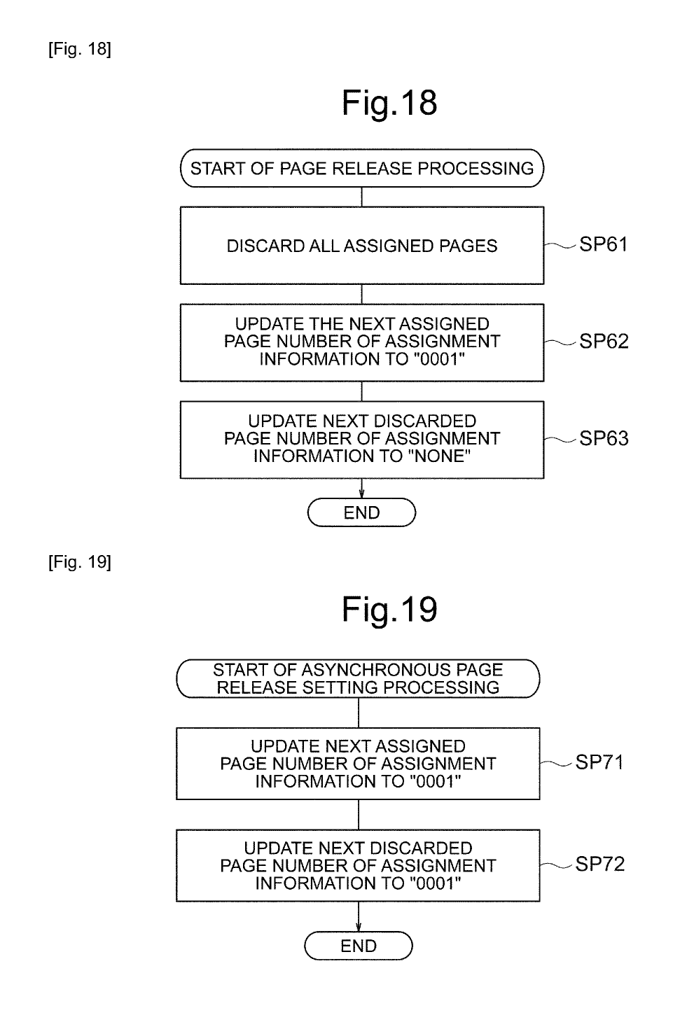

FIG. 18 shows a processing routine for page release processing. The page release processing is executed by way of co-operation between the control unit 201 of the storage apparatus 20 and the various programs which are stored in the memory 202. Further, the page release processing is executed if the secondary volume 22 is the virtual volume 204 and a page assigned to the secondary volume 22 is to be released. Further, the page release processing is executed in synchronization with the pair creation processing or the pair deletion processing. Hereinafter, for the sake of convenience, the control unit 201 will be described as the processing subject.

First, the control unit 201 discards all the assigned pages which have been assigned to the secondary volume 22 (SP61).

The control unit 201 then updates the number of the next assigned page number field 202132 of the row of the volume number corresponding to the discarded volume as 0001 on the basis of the virtual volume page assignment information 20213 (SP62).

The control unit 201 then updates the number in the next discard page number field 202133 of the row of the volume number corresponding to the discarded volume so that the number is removed on the basis of the virtual volume page assignment information 20213 (SP63), and ends the page release processing.

FIG. 19 shows a processing routine for asynchronous page release setting processing. The asynchronous page release setting processing is executed by way of co-operation between the control unit 201 of the storage apparatus 20 and the various programs stored in the memory 202. Further, the asynchronous page release setting processing is executed if the secondary volume 22 is the virtual volume 204 and a page assigned to the secondary volume 22 is released. In addition, the asynchronous page release setting processing is executed asynchronously to the pair creation processing or pair deletion processing. Hereinafter, for the sake of convenience, the control unit 201 will be described as the processing subject.

First, the control unit 201 discards all the assigned pages which have been assigned to the secondary volume 22 (SP61).

The control unit 201 then updates the number of the next assigned page number field 202132 of the row of the volume number corresponding to the discarded volume as 0001 on the basis of the virtual volume page assignment information 20213 (SP62).

The control unit 201 then updates the number of the next discard page number field 202133 of the row of the volume number corresponding to the discarded volume so that the number is removed on the basis of the virtual volume page assignment information 20213 (SP63), and ends the page release processing.

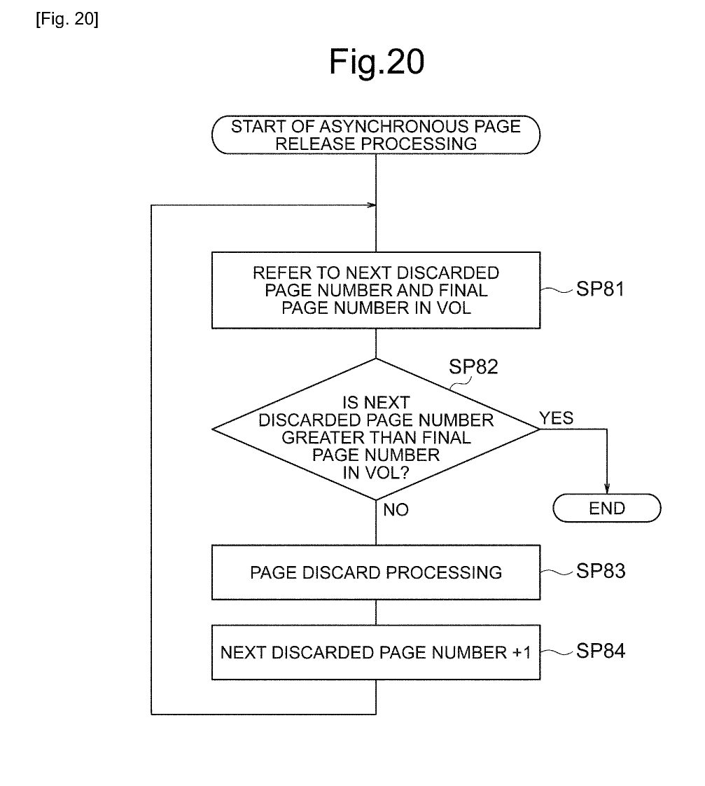

FIG. 20 shows a processing routine for asynchronous page release processing. The asynchronous page release processing is executed by way of co-operation between the control unit 201 of the storage apparatus 20 and the various programs which are stored in the memory 202. In addition, the asynchronous page release processing is executed if the secondary volume 22 is the virtual volume 204 and a page assigned to the secondary volume 22 is to be released. Further, the asynchronous page release processing is executed asynchronously to the pair creation processing or the pair deletion processing. Hereinafter, for the sake of convenience in the description, the control unit 201 will be described as the processing subject.

First, the control unit 201 refers to the next discard page number and the volume final page number on the basis of the virtual volume page assignment information 20213 (SP81).

The control unit 201 then determines whether the next discard page number is greater than the volume final page number (SP82).

Upon obtaining an affirmative result in the determination, the control unit 201 determines that there is no page to be discarded and ends the asynchronous page release processing.

If, on the other hand, a negative result is obtained in the determination of step SP82, the control unit 201 determines that there is a page to be discarded and discards the page (SP83).

After discarding the page on the basis of the virtual volume page assignment information 20213, the control unit 201 increments the page number in the next discard page number field 202133 by one (SP84), and moves to step SP81.

Further, the control unit 201 repeats the processing of steps SP81 to SP84, discards all the pages to be discarded (SP82), and ends the asynchronous page release processing.

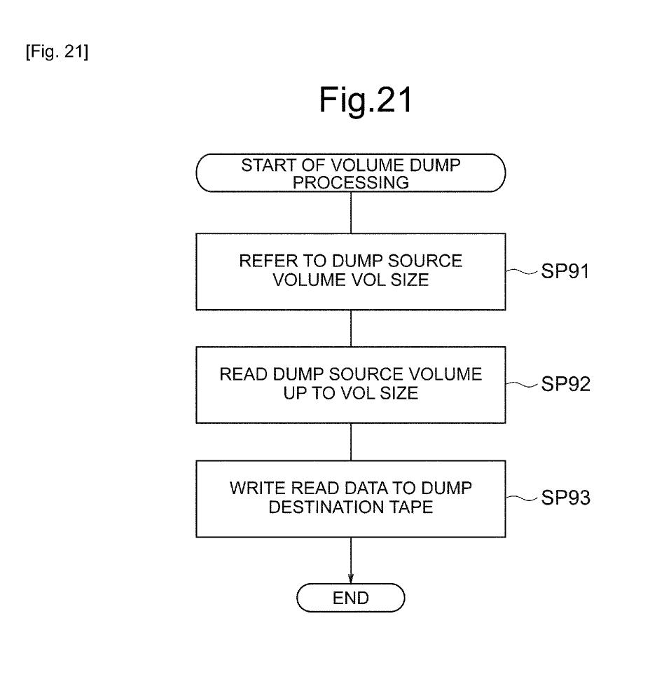

FIG. 21 shows a processing routine for volume dump processing. The volume dump processing is executed by way of co-operation between the control unit 101 of the host 10 and the various programs which are stored in the memory 102. Further, the volume dump processing is executed when the host 10 receives a volume dump instruction from the system administrator. Hereinafter, for the sake of convenience in the description, the control unit 101 will be described as the processing subject.

First, upon receiving the volume dump instruction from the system administrator via the host management IF 104, the control unit 101 acquires the copy source (dump source) volume size on the basis of the volume setting information 10211 (SP91).

Note that, here, the so-called dump source is the secondary volume 22 which is paired with the primary volume 21. Further, the data of the primary volume 21 is backed up to the secondary volume 22. The dump source volume size which is acquired here by the control unit 101 is not the actual volume size set in the storage apparatus 20, but, rather, the apparent volume size set in the host 10.

The control unit 101 then executes read processing in which the dump volume is read up to the volume size (SP92).

The control unit 101 then executes write processing to write the data stored in the read dump source volume to the magnetic tape 31 (SP93), and ends the volume dump processing.

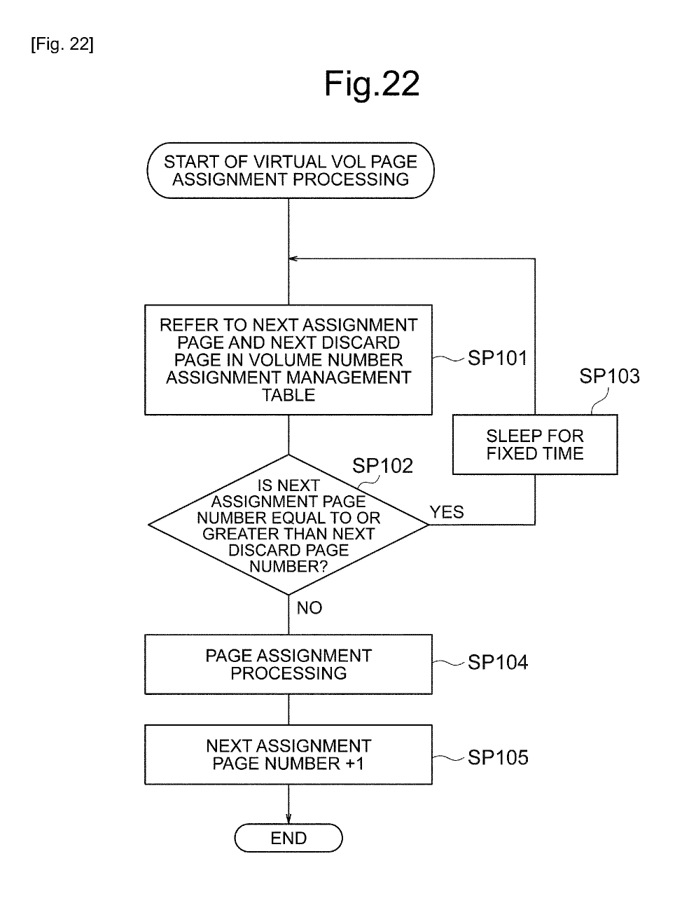

FIG. 22 shows a processing routine for the virtual volume page assignment processing. The virtual volume page assignment processing is executed by way of co-operation between the control unit 201 of the storage apparatus 20 and the various programs which are stored in the memory 202. Further, the virtual volume page assignment processing is executed when the secondary volume 22 is the virtual volume 204 and a page is to be assigned to the secondary volume 22. In addition, the virtual volume page assignment processing is executed asynchronously to the pair creation processing. Hereinafter, for the sake of convenience in the description, the control unit 201 will be described as the processing subject.

First, the control unit 201 acquires the next assigned page number and the next discard page number on the basis of virtual volume page assignment information 20213 (SP101).

The control unit 201 then determines whether or not the next assigned page number is equal to or more than the next discard page number (SP102).

When an affirmative result is obtained in the determination, the control unit 201 determines that the page assignment processing is to follow the page release processing (see FIG. 18), and that old pages have not yet been discarded but remain in the storage location of the page which is to be newly assigned, and enters standby by sleeping for a fixed time (SP103).

If, however, a negative result is obtained in the determination of step SP102, the control unit 201 executes page assignment processing to assign a page on the basis of the virtual volume page assignment information 20213 (SP104).

After page assignment processing is executed on the basis of the virtual volume page assignment information 20213, the control unit 201 increments the next assigned page number by one (SP105), and ends the virtual volume page assignment processing.

### (4) Effects of the Embodiment

As mentioned earlier, with the backup system 1 and the backup method according to the embodiment, if, during pair creation, the volume size of the secondary volume 22 is greater than the volume size of the primary volume 21, the volume size of the primary volume 21 can be reported to the host 10 as the volume size of the secondary volume 22. Accordingly, the host 10 is able to backup the data of the secondary volume 22 to the magnetic tape 31 in the range of the volume size of the primary volume 21. The processing time of a two-stage backup can thus be reduced.

In addition, with the backup system 1 and backup method according to this embodiment, there is no particular need for an operation and processing to change the volume size of the secondary volume 22 to match the volume size of the primary volume 21, and hence the two-stage backup processing time can be reduced without increasing the burden and overhead of the system administrator.

Furthermore, with the backup system 1 and backup method according to this embodiment, if, during pair deletion, the volume size of the secondary volume 22 is greater than the volume size of the primary volume 21, the actual volume size of the secondary volume 22 can be reported to the host 10. It is therefore possible to easily create a pair in accordance with the volume size of the primary volume 21.

### (5) Further Embodiments

Although the backup system 1 is configured comprising the externally connected storage apparatus 40 and the management device 50 in the foregoing embodiment, the present invention is not limited to such a configuration, rather, the backup system 1 may also be configured comprising the host 10, the storage apparatus 20, and the tape device 30.

Furthermore, the secondary volume 22 is described as being the virtual volume 204 but the present invention does not limit the secondary volume 22 to being the virtual volume 204, rather, the secondary volume 22 may also be another real volume other than the real volume 203, or the externally connected volume 41.

Further, in the pair creation processing and the pair deletion processing (see FIGS. 14 and 15), a pair create instruction and a pair delete instruction are transmitted from the host 10 to the storage apparatus 20, but the present invention is not limited to such transmission, rather, these instructions may also be transmitted to the storage apparatus 20 from the disk array management IF 207 of the storage apparatus 20 or the management device 50.

In addition, in the pair creation processing and the pair deletion processing (see FIGS. 14 and 15), page release processing is executed synchronously or asynchronously if the secondary volume 22 is the virtual volume 204, but the present invention is not limited to this arrangement, rather, page release processing need not be executed even if the secondary volume 22 is the virtual volume 204.

Moreover, in the pair creation processing (see FIG. 14), if the secondary volume 22 has a smaller volume size than the primary volume 21, the storage apparatus 20 may report the volume size of the secondary volume 22 to the host 10 as the actual volume size of the secondary volume 22.

### REFERENCE SIGNS LIST

1 Backup system
10 Host
101 Control unit
102 Memory
20 Storage apparatus
21 Primary volume
22 Secondary volume
201 Control unit
202 Memory
203 Real volume
204 Virtual volume
30 Tape device
31 Magnetic tape
40 Externally connected storage apparatus
41 Externally connected volume
50 Management device

1. A backup system in which a host, a storage apparatus, and an auxiliary storage device are interconnected and which, in accordance with a backup request from the host, executes a two-stage backup by means of the storage apparatus and the auxiliary storage device,
wherein, upon receiving a pair create instruction from the host, the storage apparatus specifies a primary volume and a secondary volume on the basis of the received pair create instruction, determines whether the volume size of the specified secondary volume is greater than the volume size of the primary volume and, if the volume size of the secondary volume is greater than the volume size of the primary volume, sets, after pair creation, the volume size of the secondary volume as the same size as the volume size of the primary volume without changing the actual volume size, and notifies the host of the set volume size of the secondary volume.

2. The backup system according to claim 1,
wherein, upon receiving a pair delete instruction from the host, the storage apparatus searches for a secondary volume which is paired with the primary volume on the basis of the received pair delete instruction, determines whether the actual volume size of the secondary volume obtained as a search result is greater than the volume size of the primary volume and, if the actual volume size of the secondary volume is greater than the volume size of the primary volume, resets, after pair deletion, the volume size of the secondary volume to the actual volume size and notifies the host of the reset volume size of the secondary volume.

3. The backup system according to claim 2,
wherein the storage apparatus comprises volume management information for managing volumes, and
wherein the storage apparatus searches for a secondary volume which can be paired with the primary volume or a secondary volume which is paired with the primary volume on the basis of the volume management information, and the pair create instruction or the pair delete instruction, and determines whether the volume size of the secondary volume obtained as a search result is greater than the volume size of the primary volume.

4. The backup system according to claim 3,
wherein the storage apparatus determines, based on the volume management information, whether the secondary volume which can be paired with the primary volume or the secondary volume which is paired with the primary volume is a virtual volume and, if the secondary volume is a virtual volume, determines whether a page is to be released on the basis of the pair create instruction or the pair delete instruction and, if a page is to be released, releases the page assigned to the secondary volume.

5. The backup system according to claim 4,
wherein, if a page assigned to the secondary volume is to be released, the storage apparatus performs synchronization with the pair creation processing or the pair deletion processing on the basis of the pair create instruction or the pair delete instruction, and releases the page asynchronously to the pair creation processing or the pair deletion processing.

6. The backup system according to claim 5,
wherein, if a page is to be released asynchronously to the pair creation processing or the pair deletion processing and if there is a conflict between the page assignment processing and the page release processing, the storage apparatus places the page assignment processing in sleep mode for a fixed time.

7. The backup system according to claim 6,
wherein the pair create instruction contains the volume numbers of the primary volume and the secondary volume, information indicating whether, during pair creation, a page assigned to the secondary volume is to be released, and a copy data amount of data backed up to the secondary volume,
wherein the pair delete instruction contains the volume numbers of the primary volume and the secondary volume and information which indicates whether, during pair deletion, a page assigned to the secondary volume is to be released, and
wherein the volume management information contains a volume number of a volume set in the storage apparatus, the type of the volume, the volume size of the volume, information indicating whether the volume is paired, a pair number if the volume is paired, and the volume size notified to the host.

8. A backup method for a backup system in which a host, a storage apparatus, and an auxiliary storage device are interconnected and which, in accordance with a backup request from the host, executes a two-stage backup by means of the storage apparatus and the auxiliary storage device,
the backup method comprising:
a first step in which, upon receiving a pair create instruction from the host, the storage apparatus specifies a primary volume and a secondary volume on the basis of the received pair create instruction, and determines whether the volume size of the specified secondary volume is greater than the volume size of the primary volume; and
a second step in which, if the volume size of the secondary volume is greater than the volume size of the primary volume, the storage apparatus sets, after pair creation, the volume size of the secondary volume as the same size as the volume size of the primary volume without changing the actual volume size, and notifies the host of the set volume size of the secondary volume.

9. The backup method according to claim 8, further comprising:
a third step in which, upon receiving a pair delete instruction from the host, the storage apparatus searches for a secondary volume which is paired with the primary volume on the basis of the received pair delete instruction, and determines whether the actual volume size of the secondary volume obtained as a search result is greater than the volume size of the primary volume; and
a fourth step in which, if the actual volume size of the secondary volume is greater than the volume size of the primary volume, the storage apparatus resets, after pair deletion, the volume size of the secondary volume to the actual volume size and notifies the host of the reset volume size of the secondary volume.

10. The backup method according to claim 9,
wherein, in the first step and the third step,
the storage apparatus comprises volume management information for managing volumes,
wherein the storage apparatus searches for a secondary volume which can be paired with the primary volume or a secondary volume which is paired with the primary volume on the basis of the volume management information, and the pair create instruction or the pair delete instruction, and
wherein the storage apparatus determines whether the volume size of the secondary volume obtained as a search result is greater than the volume size of the primary volume.

11. The backup method according to claim 10,
wherein the storage apparatus determines, based on the volume management information, whether the secondary volume which can be paired with the primary volume or the secondary volume which is paired with the primary volume is a virtual volume and, if the secondary volume is a virtual volume, determines whether a page is to be released on the basis of the pair create instruction or the pair delete instruction and, if a page is to be released, releases the page assigned to the secondary volume.

12. The backup method according to claim 11,
wherein, in the fifth step,
if a page assigned to the secondary volume is to be released, the storage apparatus performs synchronization with the pair creation processing or the pair deletion processing on the basis of the pair create instruction or the pair delete instruction, and releases the page asynchronously to the pair creation processing or the pair deletion processing.

13. The backup method according to claim 12,
wherein, in the fifth step,
if a page is to be released asynchronously to the pair creation processing or the pair deletion processing and if there is a conflict between the page assignment processing and the page release processing, the storage apparatus places the page assignment processing in sleep mode for a fixed time.

14. The backup method according to claim 13,
wherein the pair create instruction contains the volume numbers of the primary volume and the secondary volume, information indicating whether, during pair creation, a page assigned to the secondary volume is to be released, and a copy data amount of data backed up to the secondary volume,
wherein the pair delete instruction contains the volume numbers of the primary volume and the secondary volume and information which indicates whether, during pair deletion, a page assigned to the secondary volume is to be released, and
wherein the volume management information contains a volume number of a volume set in the storage apparatus, the type of the volume, the volume size of the volume, information indicating whether the volume is paired, a pair number if the volume is paired, and the volume size notified to the host.
